(19) United States
(12) Patent Application Publication
(10) Pub. No.: US 2026/0126534 A1
(43) Pub. Date: May 7, 2026

(54) MONITORING SIGNAL CHIRP IN LIDAR OUTPUT SIGNALS

(71) Applicant: SiLC Technologies, Inc., Monrovia, CA (US)

(72) Inventors: Amir Ali Tavallaee, San Francisco, CA (US); Patrick Nercessian, Burbank, CA (US); Farzin Beygi Azar Aghbolagh, Monrovia, CA (US); Bradley Jonathan Luff, La Canada Flintridge, CA (US)

(21) Appl. No.: 18/938,239

(22) Filed: Nov. 5, 2024

(51) Int. Cl. G01S 7/4911; G01S 7/481

(52) U.S. Cl. CPC G01S 7/4911; G01S 7/4812

(57) ABSTRACT

A LIDAR system is configured to output a system output signal that travels away from the LIDAR system and can be reflected by an object located outside of the LIDAR system. The system output signal includes light from an outgoing LIDAR signal. The LIDAR system has a feedback loop configured to control a frequency versus time pattern of the system output signal. The feedback loop includes an interferometer with a recirculation pathway configured such that a circulated signal travels through the recirculation pathway multiple times before being included in the output of the interferometer. The circulated signal includes light from the outgoing LIDAR signal.

### FIELD

The invention relates to optical devices. In particular, the invention relates to LIDAR systems.

### BACKGROUND

There is an increasing commercial demand for LIDAR systems that can be deployed in applications such as ADAS (Advanced Driver Assistance Systems) and AR (Augmented Reality). LIDAR (Light Detection and Ranging) systems typically output a system output signal that is reflected by an object located outside of the LIDAR system. At least a portion of the reflected light signal returns to the LIDAR system. The LIDAR system directs the received light signal to a light sensor that converts the light signal to an electrical signal. Electronics can use the light sensor output to quantify LIDAR data that indicates the radial velocity and/or distance between the object and the LIDAR system.

Many LIDAR systems tune the frequency of the system output signal linearly, or with other well-defined waveforms, over time to enable the accurate measurement of LIDAR data. In these instances, the LIDAR system can monitor the frequency of the system output signal and tune the frequency in response to the monitored frequency to achieve the desired waveform shape. The systems that monitor the frequency of the system output signal can require one or more waveguides that need to be undesirably long in order to achieve the desired results. As a result of this waveguide length, these systems often occupy a large percentage of the available space on a LIDAR chip. As a result, there is a need for an improved system for monitoring the frequency of LIDAR system output signals.

### SUMMARY

A LIDAR system is configured to output a system output signal that travels away from the LIDAR system and can be reflected by an object located outside of the LIDAR system. The system output signal includes light from an outgoing LIDAR signal. The LIDAR system has a feedback loop configured to control a frequency versus time pattern of the system output signal. The feedback loop includes an interferometer with a recirculation pathway configured such that a circulated signal travels through the recirculation pathway multiple times before being included in the output of the interferometer. The circulated signal includes light from the outgoing LIDAR signal.

In some instances, the interferometer includes a light signal combiner configured to combine light from the circulated signal with light from an expedited signal so as to generate a beating signal where the expedited signal includes light from the outgoing LIDAR signal. The LIDAR system can include a frequency identifier configured to identify a beat frequency of the outgoing LIDAR signal.

In some instances, an active portion of the circulated signal travels through the recirculation pathway an active number of times and an inactive portion of the circulated signal travels through the recirculation pathway an inactive number of times. The active number is greater than 1. The feedback loop can be configured to use the active portion of the circulated signal to control the frequency versus time pattern of the system output signal without using the inactive portion of the signal to control the frequency versus time pattern of the system output signal.

The feedback loop can include a filter configured to filter out a contribution of the inactive portion of the circulated signal from a circulation resultant signal that includes a contribution from the circulated signal. The feedback loop can be configured to use the circulation resultant signal to control the frequency versus time pattern of the system output signal.

The interferometer can include a light signal combiner configured to combine light from the circulated signal with light from an expedited signal so as to generate an optical beating signal that serves as an output of the interferometer. The expedited signal can include light from the outgoing LIDAR signal. The LIDAR system can include a beat frequency identifier configured to identify a frequency of the outgoing LIDAR signal.

### BRIEF DESCRIPTION OF THE FIGURES

FIG. 1A is a topview of a schematic of a LIDAR system that includes or consists of a LIDAR chip that outputs a LIDAR output signal and receives a LIDAR input signal on a common waveguide.

FIG. 1B is a topview of a schematic of a LIDAR system that includes or consists of a LIDAR chip that outputs a LIDAR output signal and receives a LIDAR input signal on different waveguides.

FIG. 1C is a topview of a schematic of another embodiment of a LIDAR system that that includes or consists of a LIDAR chip that outputs a LIDAR output signal and receives multiple LIDAR input signals on different waveguides.

FIG. 2 is a topview of an example of a LIDAR adapter that is suitable for use with the LIDAR chip of FIG. 1B.

FIG. 3 is a topview of an example of a LIDAR adapter that is suitable for use with the LIDAR chip of FIG. 1C.

FIG. 4 is a topview of an example of a LIDAR system that includes the LIDAR chip of FIG. 1A and the LIDAR adapter of FIG. 2 on a common support.

FIG. 5A illustrates an example of a processing component suitable for use with the LIDAR systems.

FIG. 5B provides a schematic of electronics that are suitable for use with a processing component constructed according to FIG. 5A.

FIG. 5C is a graph of a frequency versus time pattern for a system output signal with triangular frequency tuning.

FIG. 5D illustrates another example of a processing component suitable for use with the LIDAR systems.

FIG. 5E provides a schematic of electronics that are suitable for use with a processing component constructed according to FIG. 5D.

FIG. 6A and FIG. 6C illustrate an example of a suitable control component for use as all or a fraction of the control components disclosed in the context of FIG. 1A through FIG. 1C. FIG. 6A illustrates an interface between optical components and light sensors that can be positioned on a LIDAR chip.

FIG. 6B is a magnitude versus frequency graph for a delayed signal.

FIG. 6C is a schematic of a relationship between the light sources, electronics, and light sensors in a feedback loop.

FIG. 6D is a graph of a frequency versus time pattern for a system output signal with triangular frequency tuning.

FIG. 7A illustrates an interface between optical components and light sensors that can be positioned on a LIDAR chip.

FIG. 7B is a magnitude versus frequency graph for a delayed signal.

FIG. 8 is a cross-section of portion of a LIDAR chip that includes a waveguide on a silicon-on-insulator platform.

### DESCRIPTION

A LIDAR system is configured to transit a system output signal that includes light from an outgoing LIDAR signal. The system output signal can be reflected by an object located outside of the LIDAR system. At least a portion of the reflected light signal returns to the LIDAR system. The LIDAR system directs the returned light to a light sensor that converts the returned light to an electrical signal. The LIDAR system includes electronics that use the light sensor output to quantify LIDAR data that indicates the radial velocity and/or distance between the object and the LIDAR system.

The LIDAR system includes a feedback loop configured to a frequency versus time pattern of the system output signal. The feedback loop includes an interferometer that receives an interferometer input that includes light from the outgoing LIDAR signal. The interferometer splits the interferometer input such a first portion of the interferometer input is carried on a delay branch and a second portion of the interferometer input is carried on an expedited branch. The interferometer combines the portion of the interferometer input that traveled on the delay branch with the portion of the interferometer input that traveled on the expedited branch so as to generate a beating signal that can serve as the output of the interferometer. The expedited branch and the delay branch are constructed such that the distance that the first portion of the interferometer input travels through the delay branch is different from the distance that the second portion of the interferometer input travels through the expedited branch. The beating signal is beating at a beat frequency due to the difference in the distance traveled by the first portion of the interferometer input and the second portion of the interferometer input.

The delay branch includes a recirculation pathway configured such that light traveling through the delay branch can travel through the recirculation pathway one or more times before being included in the output of the interferometer. Accordingly, light from the first portion of the first portion of the interferometer input can travel through the recirculation pathway one or more times before being included in the beating signal. The electronics use the portion of the beating signal that includes light that has traveled along the recirculation pathway multiple times to control the frequency versus time pattern of the system output signal.

Since the light used to control the frequency versus time pattern travels through the recirculation pathway multiple times before being output by the interferometer, the length of the delay pathway can be reduced while still providing the desired level of delay between the delay branch and the expedited branch. As a result, the amount of the space occupied by the delay branch is reduced.

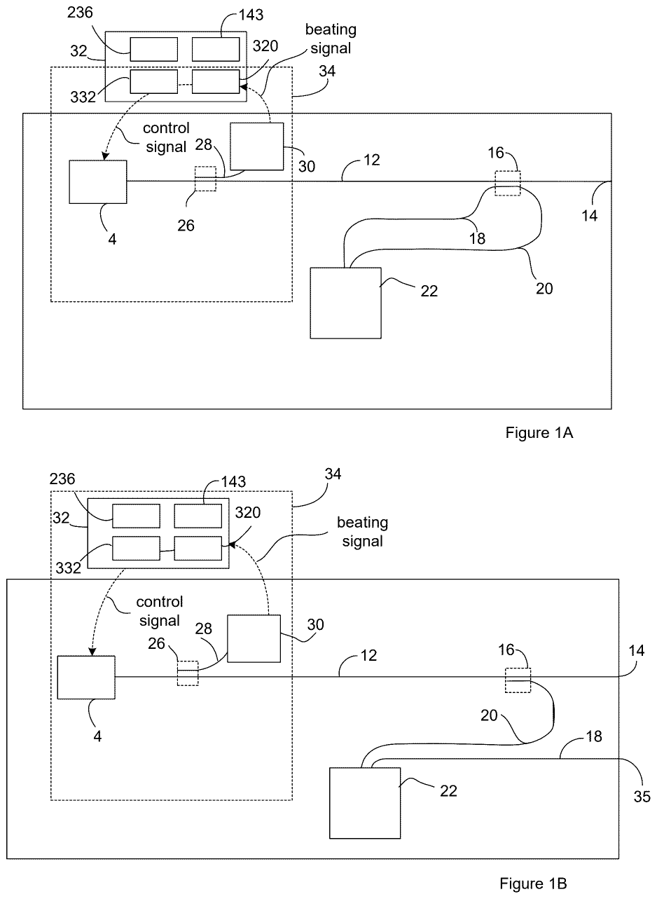

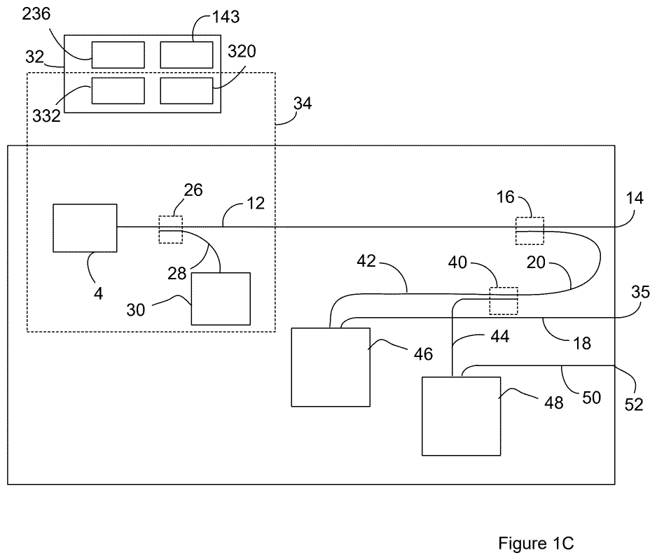

FIG. 1A is a topview of a schematic of a LIDAR chip that can serve as a LIDAR system or can be included in a LIDAR system that includes components in addition to the LIDAR chip. The LIDAR chip can include a Photonic Integrated Circuit (PIC) and can be a Photonic Integrated Circuit chip. The LIDAR chip includes a light source 4 that outputs a preliminary outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal. In some instances, the portion of the LIDAR output signal that has exited from the LIDAR chip can also be considered a system output signal. As an example, when the exit of the LIDAR output signal from the LIDAR chip is also an exit of the LIDAR output signal from the LIDAR system, the LIDAR output signal can also be considered a system output signal.

The LIDAR output signal travels away from the LIDAR system through free space in the atmosphere in which the LIDAR system is positioned. The LIDAR output signal may be reflected by one or more objects in the path of the LIDAR output signal. When the LIDAR output signal is reflected, at least a portion of the reflected light travels back toward the LIDAR chip as a LIDAR input signal. In some instances, the LIDAR input signal can also be considered a system return signal. As an example, when the exit of the LIDAR output signal from the LIDAR chip is also an exit of the LIDAR output signal from the LIDAR system, the LIDAR input signal can also be considered a system return signal.

The LIDAR input signals can enter the utility waveguide 12 through the facet 14. The portion of the LIDAR input signal that enters the utility waveguide 12 serves as an incoming LIDAR signal. The utility waveguide 12 carries the incoming LIDAR signal to a splitter 16 that moves a portion of the outgoing LIDAR signal from the utility waveguide 12 onto a comparative waveguide 18 as a comparative signal. The comparative waveguide 18 carries the comparative signal to a processing component 22 for further processing. Although FIG. 1A illustrates a directional coupler operating as the splitter 16, other signal tapping components can be used as the splitter16. Suitable splitters 16 include, but are not limited to, directional couplers, optical couplers, y-junctions, tapered couplers, and Multi-Mode Interference (MMI) devices.

The utility waveguide 12 also carries the outgoing LIDAR signal to the splitter 16. The splitter 16 moves a portion of the outgoing LIDAR signal from the utility waveguide 12 onto a reference waveguide 20 as a reference signal. The reference waveguide 20 carries the reference signal to the processing component 22 for further processing.

The percentage of light transferred from the utility waveguide 12 by the splitter 16 can be fixed or substantially fixed. For instance, the splitter 16 can be configured such that the power of the reference signal transferred to the reference waveguide 20 is an outgoing percentage of the power of the outgoing LIDAR signal or such that the power of the comparative signal transferred to the comparative waveguide 18 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 16, such as a multimode interferometer (MMI), generally provides an outgoing percentage and an incoming percentage of 50% or about 50%. However, multimode interferometers (MMIs) can be easier to fabricate in platforms such as silicon-on-insulator platforms than some alternatives. In one example, the splitter 16 is a multimode interferometer (MMI) and the outgoing percentage and the incoming percentage are 50% or substantially 50%. As will be described in more detail below, the processing component 22 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control branch for controlling operation of the light source 4. The control branch includes a splitter 26 that moves a portion of the outgoing LIDAR signal from the utility waveguide 12 onto a control waveguide 28. The coupled portion of the outgoing LIDAR signal serves as a tapped signal. Although FIG. 1A illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the tapped signal to control components 30. The control components 30 can be in electrical communication with electronics 32. All or a portion of the control components 30 can be included in the electronics 32. During operation, the electronics can employ output from the control components 30 in a feedback loop 34 configured to control a frequency versus time pattern of a controlled light signal such as the tapped signal.

The LIDAR system can be modified so the incoming LIDAR signal and the outgoing LIDAR signal can be carried on different waveguides. For instance, FIG. 1B is a topview of the LIDAR chip of FIG. 1A modified such that the incoming LIDAR signal and the outgoing LIDAR signal are carried on different waveguides. The outgoing LIDAR signal exits the LIDAR chip through the facet 14 and serves as the LIDAR output signal. When light from the LIDAR output signal is reflected by an object external to the LIDAR system, at least a portion of the reflected light returns to the LIDAR chip as a first LIDAR input signal. The first LIDAR input signal enters the comparative waveguide 18 through a facet 35 and serves as the comparative signal. The comparative waveguide 18 carries the comparative signal to a processing component 22 for further processing. As described in the context of FIG. 1A, the reference waveguide 20 carries the reference signal to the processing component 22 for further processing. As will be described in more detail below, the processing component 22 combines the comparative signal with the reference signal to form a composite signal that carries LIDAR data for a sample region on the field of view.

The LIDAR chips can be modified to receive multiple LIDAR input signals. For instance, FIG. 1C illustrates the LIDAR chip of FIG. 1B modified to receive two LIDAR input signals. A splitter 40 is configured to place a portion of the reference signal carried on the reference waveguide 20 on a first reference waveguide 42 and another portion of the reference signal on a second reference waveguide 44. Accordingly, the first reference waveguide 42 carries a first reference signal and the second reference waveguide 44 carries a second reference signal. The first reference waveguide 42 carries the first reference signal to a first processing component 46 and the second reference waveguide 44 carries the second reference signal to a second processing component 48. Examples of suitable splitters 40 include, but are not limited to, y-junctions, optical couplers, and multi-mode interference couplers (MMIs).

The outgoing LIDAR signal exits the LIDAR chip through the facet 14 and serves as the LIDAR output signal. When light from the LIDAR output signal is reflected by one or more objects located external to the LIDAR system, at least a portion of the reflected light returns to the LIDAR chip as a first LIDAR input signal. The first LIDAR input signal enters the comparative waveguide 18 through the facet 35 and serves as a first comparative signal. The comparative waveguide 18 carries the first comparative signal to a first processing component 46 for further processing.

Additionally, when light from the LIDAR output signal is reflected by one or more objects located external to the LIDAR system, at least a portion of the reflected signal returns to the LIDAR chip as a second LIDAR input signal. The second LIDAR input signals enter a second comparative waveguide 50 through a facet 52 and serves as a second comparative signal carried by the second comparative waveguide 50. The second comparative waveguide 50 carries the second comparative signal to a second processing component 48 for further processing.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

In some instances, a LIDAR chip constructed according to FIG. 1B or FIG. 1C is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the first LIDAR input signal and the LIDAR output signal such that the first LIDAR input signal and the LIDAR output signal travel on different optical pathways between the LIDAR adapter and the LIDAR chip but on the same optical pathway between the LIDAR adapter and a reflecting object in the field of view.

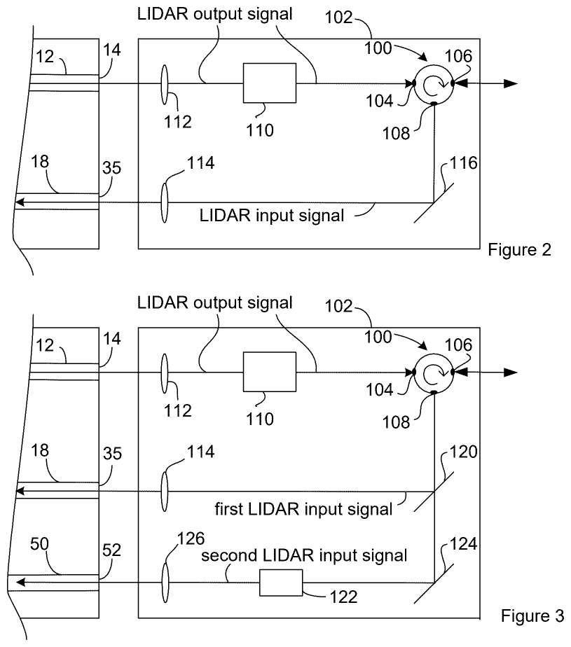

An example of a LIDAR adapter that is suitable for use with the LIDAR chip of FIG. 1B is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in the sample region reflect the LIDAR output signal, at least a portion of the reflected light travels back to the circulator 100 as a system return signal. The system return signal enters the circulator 100 through the second port 106. FIG. 2 illustrates the LIDAR output signal and the system return signal traveling between the LIDAR adapter and the sample region along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal to the facet 35 of the comparative waveguide 18.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers and the remaining components are discrete components.

The LIDAR system can be configured to compensate for polarization. Light from a laser source is typically linearly polarized and hence the LIDAR output signal is also typically linearly polarized. Reflection from an object may change the angle of polarization of the returned light. Accordingly, the system return signal can include light of different linear polarization states. For instance, a first portion of a system return signal can include light of a first linear polarization state and a second portion of a system return signal can include light of a second linear polarization state. The intensity of the resulting composite signals is proportional to the square of the cosine of the angle between the comparative and reference signal polarization fields. If the angle is 90 degrees, the LIDAR data can be lost in the resulting composite signal. However, the LIDAR system can be modified to compensate for changes in polarization state of the LIDAR output signal.

FIG. 3 illustrates the LIDAR system of FIG. 3 modified such that the LIDAR adapter is suitable for use with the LIDAR chip of FIG. 1C. The LIDAR adapter includes a beamsplitter 120 that receives the system return signal from the circulator 100. The beamsplitter 120 splits the system return signal into a first portion of the system return signal and a second portion of the system return signal. Suitable beamsplitters include, but are not limited to, Wollaston prisms, and MEMS-based beamsplitters.

The first portion of the system return signal is directed to the comparative waveguide 18 on the LIDAR chip and serves as the first LIDAR input signal described in the context of FIG. 1C. The second portion of the system return signal is directed a polarization rotator 122. The polarization rotator 122 outputs a second LIDAR input signal that is directed to the second input waveguide 76 on the LIDAR chip and serves as the second LIDAR input signal.

The beamsplitter 120 can be a polarizing beam splitter. One example of a polarizing beamsplitter is constructed such that the first portion of the system return signal has a first polarization state but does not have or does not substantially have a second polarization state and the second portion of the system return signal has a second polarization state but does not have or does not substantially have the first polarization state. The first polarization state and the second polarization state can be linear polarization states and the second polarization state is different from the first polarization state. For instance, the first polarization state can be TE and the second polarization state can be TM or the first polarization state can be TM and the second polarization state can be TE. In some instances, the laser source can be linearly polarized such that the LIDAR output signal has the first polarization state. Suitable beamsplitters include, but are not limited to, Wollaston prisms, and MEMs-based polarizing beamsplitters.

A polarization rotator can be configured to change the polarization state of the first portion of the system return signal and/or the second portion of the system return signal. For instance, the polarization rotator 122 shown in FIG. 3 can be configured to change the polarization state of the second portion of the system return signal from the second polarization state to the first polarization state. As a result, the second LIDAR input signal has the first polarization state but does not have or does not substantially have the second polarization state. Accordingly, the first LIDAR input signal and the second LIDAR input signal each have the same polarization state (the first polarization state in this example). Despite carrying light of the same polarization state, the first LIDAR input signal and the second LIDAR input signal are associated with different polarization states as a result of the use of the polarizing beamsplitter. For instance, the first LIDAR input signal carries the light reflected with the first polarization state and the second LIDAR input signal carries the light reflected with the second polarization state. As a result, the first LIDAR input signal is associated with the first polarization state and the second LIDAR input signal is associated with the second polarization state.

Since the first LIDAR input signal and the second LIDAR carry light of the same polarization state, the comparative signals that result from the first LIDAR input signal have the same polarization angle as the comparative signals that result from the second LIDAR input signal.

Suitable polarization rotators include, but are not limited to, rotation of polarization-maintaining fibers, Faraday rotators, half-wave plates, MEMs-based polarization rotators and integrated optical polarization rotators using asymmetric y-branches, Mach-Zehnder interferometers and multi-mode interference couplers.

Since the outgoing LIDAR signal is linearly polarized, the first reference signals can have the same linear polarization state as the second reference signals. Additionally, the components on the LIDAR adapter can be selected such that the first reference signals, the second reference signals, the comparative signals and the second comparative signals each have the same polarization state. In the example disclosed in the context of FIG. 3, the first comparative signals, the second comparative signals, the first reference signals, and the second reference signals can each have light of the first polarization state.

As a result of the above configuration, first composite signals generated by the first processing component 46 and second composite signals generated by the second processing component 48 each results from combining a reference signal and a comparative signal of the same polarization state and will accordingly provide the desired beating between the reference signal and the comparative signal. For instance, the composite signal results from combining a first reference signal and a first comparative signal of the first polarization state and excludes or substantially excludes light of the second polarization state or the composite signal results from combining a first reference signal and a first comparative signal of the second polarization state and excludes or substantially excludes light of the first polarization state. Similarly, the second composite signal includes a second reference signal and a second comparative signal of the same polarization state will accordingly provide the desired beating between the reference signal and the comparative signal. For instance, the second composite signal results from combining a second reference signal and a second comparative signal of the first polarization state and excludes or substantially excludes light of the second polarization state or the second composite signal results from combining a second reference signal and a second comparative signal of the second polarization state and excludes or substantially excludes light of the first polarization state.

The above configuration results in the LIDAR data for a single sample region in the field of view being generated from multiple different composite signals (i.e. first composite signals and the second composite signal) from the sample region. In some instances, determining the LIDAR data for the sample region includes the electronics combining the LIDAR data from different composite signals (i.e. the composite signals and the second composite signal). Combining the LIDAR data can include taking an average, median, or mode of the LIDAR data generated from the different composite signals. For instance, the electronics can average the distance between the LIDAR system and the reflecting object determined from the composite signal with the distance determined from the second composite signal and/or the electronics can average the radial velocity between the LIDAR system and the reflecting object determined from the composite signal with the radial velocity determined from the second composite signal.

In some instances, determining the LIDAR data for a sample region includes the electronics identifying one or more composite signals (i.e. the composite signal and/or the second composite signal) as the source of the LIDAR data that is most represents reality (the representative LIDAR data). The electronics can then use the LIDAR data from the identified composite signal as the representative LIDAR data to be used for additional processing. For instance, the electronics can identify the signal (composite signal or the second composite signal) with the larger amplitude as having the representative LIDAR data and can use the LIDAR data from the identified signal for further processing by the LIDAR system. In some instances, the electronics combine identifying the composite signal with the representative LIDAR data with combining LIDAR data from different LIDAR signals. For instance, the electronics can identify each of the composite signals with an amplitude above an amplitude threshold as having representative LIDAR data and when more than two composite signals are identified as having representative LIDAR data, the electronics can combine the LIDAR data from each of identified composite signals. When one composite signal is identified as having representative LIDAR data, the electronics can use the LIDAR data from that composite signal as the representative LIDAR data. When none of the composite signals is identified as having representative LIDAR data, the electronics can discard the LIDAR data for the sample region associated with those composite signals.

Although FIG. 3 is described in the context of components being arranged such that the first comparative signals, the second comparative signals, the first reference signals, and the second reference signals each have the first polarization state, other configurations of the components in FIG. 3 can arranged such that the composite signals result from combining a reference signal and a comparative signal of the same linear polarization state and the second composite signal results from combining a reference signal and a comparative signal of the same linear polarization state. For instance, the beamsplitter 120 can be constructed such that the second portion of the system return signal has the first polarization state and the first portion of the system return signal has the second polarization state, the polarization rotator receives the first portion of the system return signal, and the outgoing LIDAR signal can have the second polarization state. In this example, the first LIDAR input signal and the second LIDAR input signal each has the second polarization state.

The above system configurations result in the first portion of the system return signal and the second portion of the system return signal being directed into different composite signals. As a result, since the first portion of the system return signal and the second portion of the system return signal are each associated with a different polarization state but electronics can process each of the composite signals, the LIDAR system compensates for changes in the polarization state of the LIDAR output signal in response to reflection of the LIDAR output signal.

The LIDAR adapter of FIG. 3 can include additional optical components including passive optical components. For instance, the LIDAR adapter can include an optional third lens 126. The third lens 126 can be configured to couple the second LIDAR output signal at a desired location. In some instances, the third lens 126 focuses or collimates the second LIDAR output signal at a desired location. For instance, the third lens 126 can be configured to focus or collimate the second LIDAR output signal on the facet 52 of the second comparative waveguide 50. The LIDAR adapter also includes one or more direction changing components 124 such as mirrors and prisms. FIG. 3 illustrates the LIDAR adapter including a mirror as a direction changing component 124 that redirects the second portion of the system return signal from the circulator 100 to the facet 52 of the second comparative waveguide 50 and/or to the third lens 126.

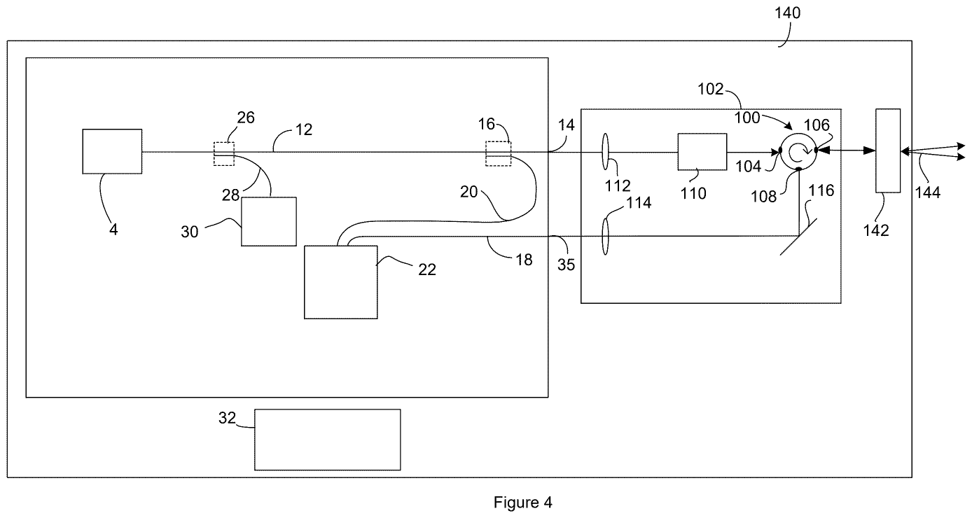

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 4 is a topview of a LIDAR system that includes the LIDAR chip and electronics 32 of FIG. 1A and the LIDAR adapter of FIG. 2 on a common support 140. Although the electronics 32 are illustrated as being located on the common support, all or a portion of the electronics can be located off the common support. When the light source 4 is located off the LIDAR chip, the light source can be located on the common support 140 or off of the common support 140. Suitable approaches for mounting the LIDAR chip, electronics, and/or the LIDAR adapter on the common support include, but are not limited to, epoxy, solder, and mechanical clamping.

The LIDAR systems can include components including additional passive and/or active optical components. For instance, the LIDAR system can include one or more components that receive the LIDAR output signal from the LIDAR chip or from the LIDAR adapter. The portion of the LIDAR output signal that exits from the one or more components can serve as the system output signal. As an example, the LIDAR system can include one or more beam scanners that receive the LIDAR output signal from the LIDAR chip or from the LIDAR adapter and that output all or a fraction of the LIDAR output signal that serves as the system output signal. For instance, FIG. 4 illustrates a beam scanner 142 that receive a LIDAR output signal from the LIDAR adapter. Although FIG. 4 shows the beam scanner positioned on the common support 140, the beam scanner can be positioned on the LIDAR chip, on the LIDAR adapter, off the LIDAR chip, or off the common support 140. Suitable beam scanners include, but are not limited to, movable mirrors, MEMS mirrors, optical phased arrays (OPAs), and actuators that move the LIDAR chip, LIDAR adapter, and/or common support.

The electronics can include a steering controller 143 configured to operate the one or more beam scanner 142 so as to steer the system output signal to different sample regions 144. The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

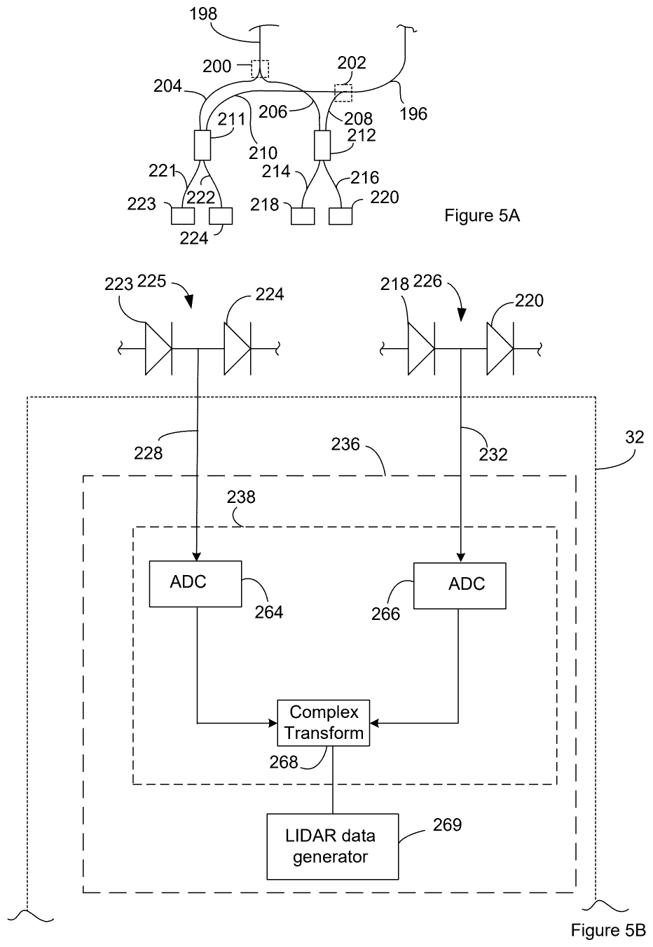

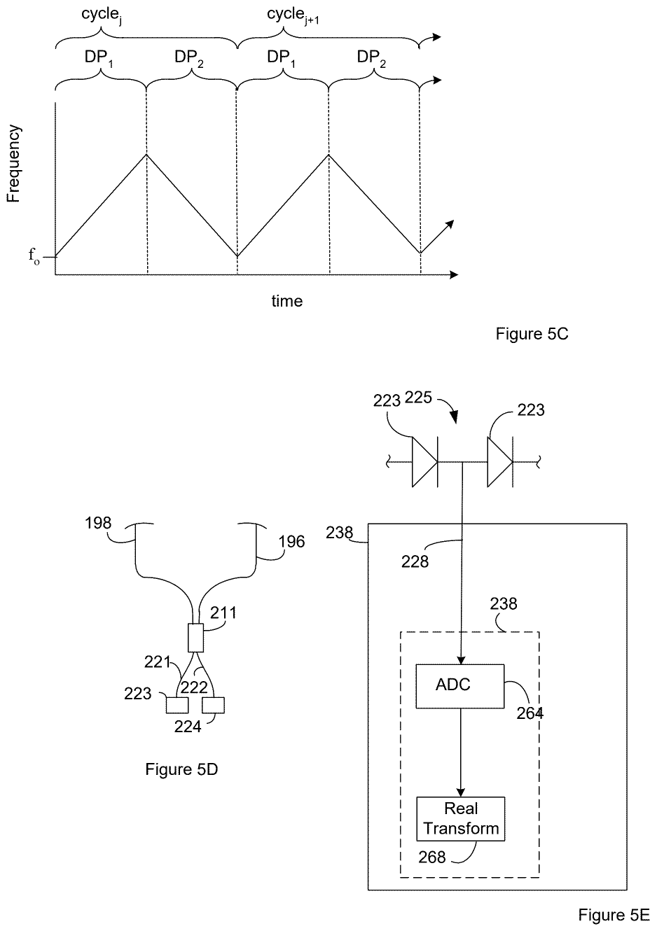

FIG. 5A through FIG. 5C illustrate an example of a suitable processing component for use as all or a fraction of the processing components selected from the group consisting of the processing component 22, the first processing component 46 and the second processing component 48. The processing component receives a comparative signal from a comparative waveguide 196 and a reference signal from a reference waveguide 198. The comparative waveguide 18 and the reference waveguide 20 shown in FIG. 1A and FIG. 1B can serve as the comparative waveguide 196 and the reference waveguide 198, the comparative waveguide 18 and the first reference waveguide 42 shown in FIG. 1C can serve as the comparative waveguide 196 and the reference waveguide 198, or the second comparative waveguide 50 and the second reference waveguide 44 shown in FIG. 1C can serve as the comparative waveguide 196 and the reference waveguide 198.

The processing component includes a second splitter 200 that divides the comparative signal carried on the comparative waveguide 196 onto a first comparative waveguide 204 and a second comparative waveguide 206. The first comparative waveguide 204 carries a first portion of the comparative signal to the signal combiner 211. The second comparative waveguide 208 carries a second portion of the comparative signal to the second signal combiner 212.

The processing component includes a first splitter 202 that divides the reference signal carried on the reference waveguide 198 onto a first reference waveguide 204 and a second reference waveguide 206. The first reference waveguide 204 carries a first portion of the reference signal to the signal combiner 211. The second reference waveguide 208 carries a second portion of the reference signal to the second signal combiner 212.

The second signal combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second signal combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second signal combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second signal combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first signal combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first signal combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the signal combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the signal combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second signal combiner 212 splits the second composite signal such that the portion of the comparative signal in the first portion of the second composite signal is phase shifted by 180° relative to the portion of the comparative signal in the second portion of the second composite signal, the signal combiner 211 also splits the composite signal such that the portion of the comparative signal in the first portion of the composite signal is phase shifted by 180° relative to the portion of the comparative signal in the second portion of the composite signal. When the second signal combiner 212 splits the second composite signal such that the portion of the reference signal in the first portion of the second composite signal is phase shifted by 180° relative to the portion of the reference signal in the second portion of the second composite signal, the signal combiner 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

In the LIDAR system disclosed in the context of FIG. 4 and FIG. 5A, the composite signals, the comparative signals, the LIDAR input signals, the system return signals, the system output signals, and the LIDAR output signals include light from the outgoing LIDAR signal. In the LIDAR system disclosed in the context of FIG. 4 and FIG. 5A, the composite signals, the comparative signals, the LIDAR input signals, the system return signals, and the system output signals include light from the LIDAR output signals. In the LIDAR system disclosed in the context of FIG. 4 and FIG. 5A, the composite signals, the comparative signals, the LIDAR input signals, and the system return signals include light from the system output signals. In the LIDAR system disclosed in the context of FIG. 4 and FIG. 5A, the composite signals, the comparative signals, and the LIDAR input signals include light from the system return signals. In the LIDAR system disclosed in the context of FIG. 4 and FIG. 5A, the composite signals, and the comparative signals, include light from the LIDAR input signals. In the LIDAR system disclosed in the context of FIG. 4 and FIG. 5A, the composite signals include light from the comparative signals.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 32 include a data processor 236 configured to generate LIDAR data for the sample regions. The data processor 236 includes a transform mechanism 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transform mechanism 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transform mechanism 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transform mechanism 238 includes a transform component 268 that receives the complex data signal. For instance, the transform component 268 receives the first digital data signal from the first Analog-to-Digital Converter (ADC) 264 as an input and also receives the second digital data signal from the second Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The transform mechanism 238 includes can include a peak finder (not shown) configured to identify peaks in the output of the transform mechanism 238 includes. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal and accordingly of the data signal.

The data processor 236 includes a LIDAR data generator 269 configured to receive the output from the transform component 268. For instance, the LIDAR data generator 269 can receive the beat frequency from the transform component 268. The LIDAR data generator 269 treats the frequency at the identified peak as the beat frequency of the comparative signal beating against all or a portion of a reference signal. The LIDAR data generator 269 can use the received beat frequencies in combination with the frequency pattern of the LIDAR output signals and/or the system output signals to generate LIDAR data results (distance and/or radial velocity between the reflecting object and the LIDAR chip or LIDAR system).

FIG. 5C shows an example of a relationship between the frequency of the system output signal, time, cycles and chirp periods. The base frequency of the system output signal (fₒ) can be the lowest frequency of the system output signal during a chirp period.

FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan.

Each cycle includes K chirp periods that are each associated with a period index k and are labeled DPₖ. In the example of FIG. 5C, each cycle includes two chirp periods labeled DPₖ with k=1 and 2. In some instances, the frequency versus time pattern is the same for the chirp periods that correspond to each other in different cycles as is shown in FIG. 5C. Corresponding chirp periods are chirp periods with the same period index. As a result, each chirp period DP₁ can be considered corresponding chirp periods and the associated frequency versus time patterns are the same in FIG. 5C. At the end of a cycle, the electronics return the frequency to the same frequency level at which it started the previous cycle.

During the chirp period DP₁, and the chirp period DP₂, the frequency of the system output signal is linearly chirped. For instance, the feedback loop can be configured to operate the light source such that the frequency of the system output signal changes at a linear rate α during the chirp periods DP₁ and DP₂. The direction of the frequency change during the chirp period DP₁ is the opposite of the direction of the frequency change during the chirp period DP₂.

The frequency output from the Complex Fourier transform represents the beat frequency of the composite signals that each includes a comparative signal beating against a reference signal. The beat frequencies (f_{LDP}) from two or more different chirp periods can be combined to generate the LIDAR data. For instance, the beat frequency determined from DP₁ in FIG. 5C can be combined with the beat frequency determined from DP₂ in FIG. 5C to determine the LIDAR data. As an example, the following equation applies during a chirp period where electronics increase the frequency of the outgoing LIDAR signal during the chirp period such as occurs in chirp period DP₁ of FIG. 5C: f_{ub}=−f_{d}+ατ where f_{ub} is the frequency provided by the transform component 268 (f_{LDP} determined from DP₁ in this case), f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the LIDAR system is assumed to be the positive direction, and c is the speed of light. The following equation applies during a chirp period where electronics decrease the frequency of the outgoing LIDAR signal such as occurs in chirp period DP₂ of FIG. 5C: f_{db}=−f_{d}−ατ where f_{db} is a frequency provided by the transform component 268 (f_{i, LDP} determined from DP₂ in this case). In these two equations, f_{d} and τ are unknowns. These two equations can be solved for the two unknowns. The LIDAR data generator can calculate the radial velocity for the sample region from the Doppler shift (ν=c*f_{d}/(2f_{c})) and/or the separation distance for that sample region can be quantified from c*f_{d}/2.

In some instances, more than one object is present in a sample region. In some instances when more than one object is present in a sample region, the transform may output more than one frequency where each frequency is associated with a different object. The frequencies that result from the same object in different chirp periods of the same cycle can be considered corresponding frequency pairs. LIDAR data can be generated for each corresponding frequency pair output by the transform. As a result, separate LIDAR data can be generated for each of the objects in a sample region.

Although FIG. 5A through FIG. 5B illustrate signal combiners that combine a portion of the reference signal with a portion of the comparative signal, the processing component can include a single signal combiner that combines the reference signal with the comparative signal so as to form a composite signal. As a result, at least a portion of the reference signal and at least a portion of the comparative signal can be combined to form a composite signal. The combined portion of the reference signal can be the entire reference signal or a fraction of the reference signal and the combined portion of the comparative signal can be the entire comparative signal or a fraction of the comparative signal.

As an example of a processing component that combines the reference signal and the comparative signal so as to form a composite signal, FIG. 5D through FIG. 5E illustrate the processing component of FIG. 5A through FIG. 5B modified to include a single signal combiner. The comparative waveguide 196 carries the comparative signal directly to the first signal combiner 211 and the reference waveguide 198 carries the reference signal directly to the first signal combiner 211.

The first signal combiner 211 combines the comparative signal and the reference signal into a composite signal. Due to the difference in frequencies between the comparative signal and the reference signal, the first composite signal is beating between the comparative signal and the reference signal. The first signal combiner 211 also splits the composite signal onto the first detector waveguide 221 and the second detector waveguide 222. The first detector waveguide 221 carries a first portion of the composite signal to the first light sensor 223 that converts the first portion of the second composite signal to a first electrical signal. The second detector waveguide 222 carries a second portion of the composite signal to the second light sensor 224 that converts the second portion of the second composite signal to a second electrical signal.

FIG. 5E provides a schematic of the relationship between the electronics, the first light sensor 223, and the second light sensor 224. The symbol for a photodiode is used to represent the first light sensor 223, and the second light sensor 224 but one or more of these sensors can have other constructions. In some instances, all of the components illustrated in the schematic of FIG. 5E are included on the LIDAR chip. In some instances, the components illustrated in the schematic of FIG. 5E are distributed between the LIDAR chip and electronics located off of the LIDAR chip.

The electronics connect the first light sensor 223 and the second light sensor 224 as a first balanced detector 225. In particular, the first light sensor 223 and the second light sensor 224 are connected in series. The serial connection in the first balanced detector is in communication with a first data line 228 that carries the output from the first balanced detector as a first data signal. The first data signal is an electrical representation of the composite signal.

The electronics 32 include a transform mechanism 238 configured to perform a mathematical transform on the first data signal. The mathematical transform can be a real Fourier transform with the first data signal as an input. The electronics can use the frequency output from the transform as described above to extract the LIDAR data.

Each of the balanced detectors disclosed in the context of FIG. 5A through FIG. 5E can be replaced with a single light sensor. As a result, the processing component can include one or more light sensors that each receives at least a portion of a composite signal in that the received portion of the composite signal can be the entire composite signal or a fraction of the composite signal.

As discussed in the context of FIG. 5C, the electronics 32 tune the frequency of the system output signal. One method to produce this frequency chirp is to modulate the electrical current applied to the light source by the electronics. In semiconductor lasers that can be used as the light source in the LIDAR system, current modulation results in frequency modulation via nonlinear carrier/photon coupling.

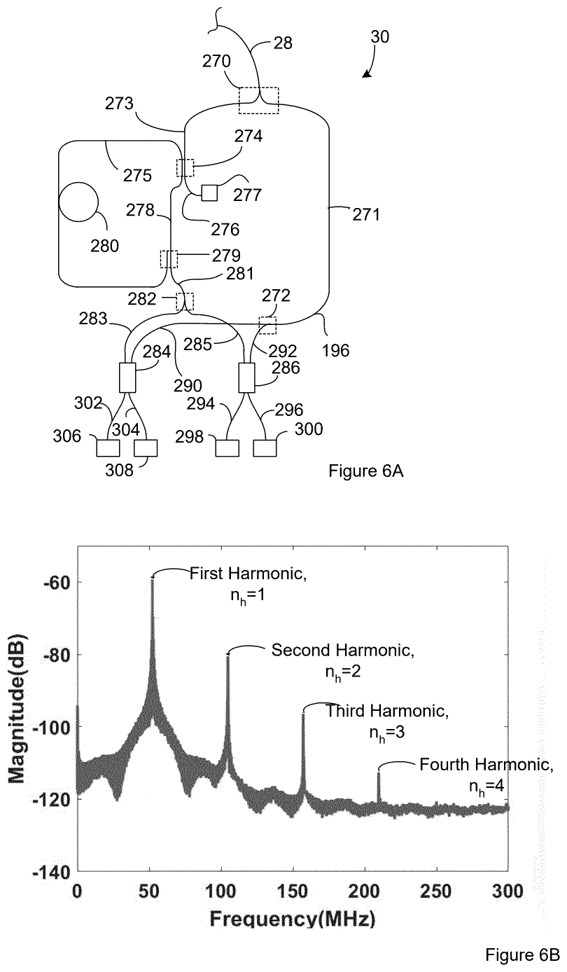

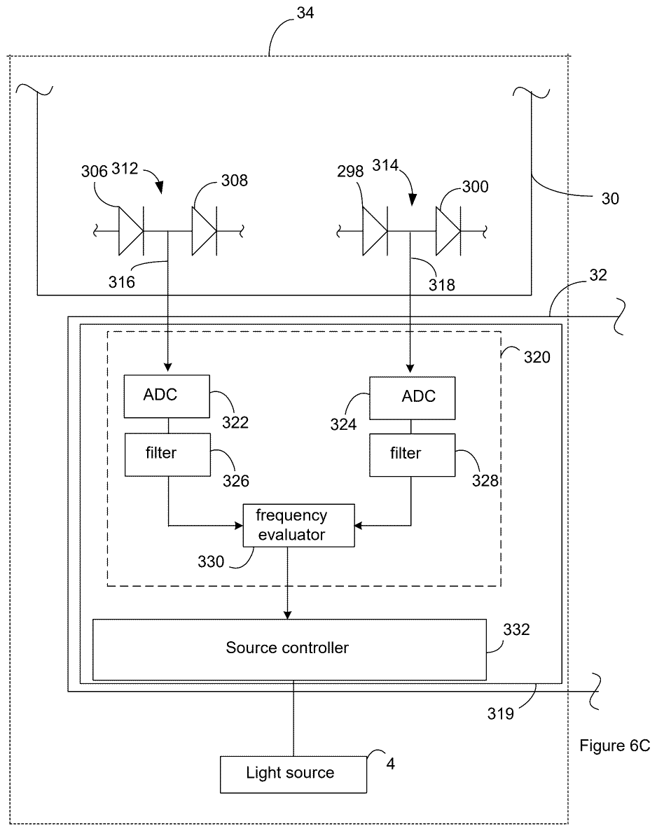

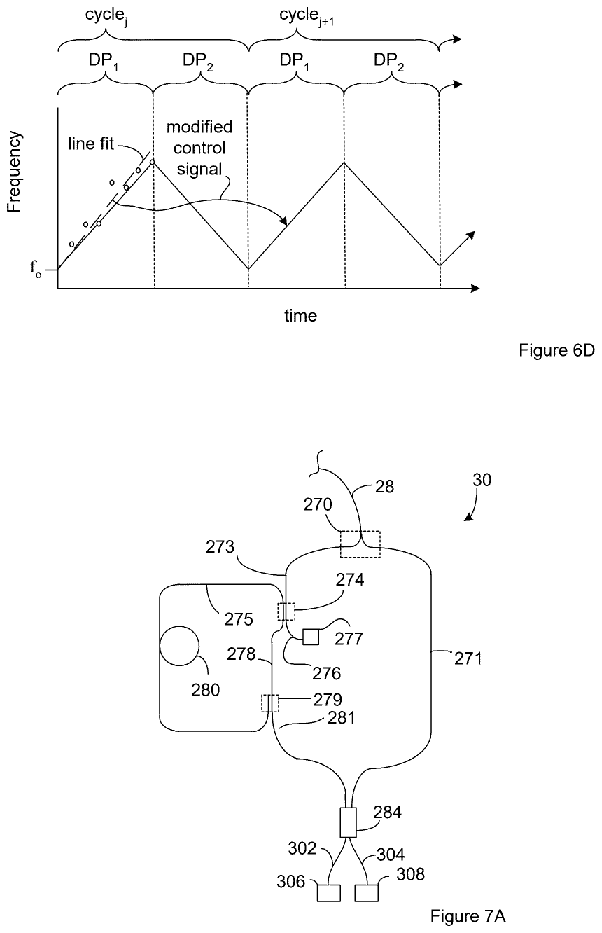

FIG. 6A through FIG. 6D illustrate an example of a suitable control component for use as all or a fraction of the control components 30 disclosed in the context of FIG. 1A through FIG. 1C and FIG. 4. The control components 30 includes an interferometer configured to use light from the tapped signal to create an optical beating signal with an in-phase component and a quadrature component. Suitable interferometers include, but are not limited to, Mach-Zehnder interferometers.

The interferometer receives the tapped signal from the control waveguide 28. The portion of the tapped signal received by the interferometer can serve as the input for the interferometer. The interferometer includes a splitter 270 that can serve as the input for the interferometer. The splitter 270 receives the interferometer input from the control waveguide 28. The splitter 270 divides the interferometer input into a delay signal (first portion of the interferometer input) and an expedited signal (second portion of the interferometer input). Light from the delay signal travels through a delay branch of the interferometer and light from the expedited signal travels through an expedited branch of the interferometer. For instance, an expedited waveguide 271 carries the expedited signal to a first splitter 272.

A delay branch waveguide 273 carries the delay signal to a signal mixer 274. The signal mixer 274 is configured to mix the delay signal with a recirculation signal carried on a recirculation waveguide 275 so as to generate a composite recirculation signal. The signal mixer is also configured to divide the composite recirculation signal into a preliminary recirculation signal and a dump signal. A dump waveguide receives the dump signal from the signal mixer 274 and carries the dump signal to a beam dump configured to scatter and/or absorb the dump signal. In some instances, the signal mixer 274 is configured such that a power ratio of the power of the preliminary recirculation signal: the power of the preliminary recirculation signal and a dump signal is greater than 1:1, 2:1 or 3:1 and less than 4:1, 8:1 or 20:1.

A preliminary recirculation waveguide 278 receives the preliminary recirculation signal from the signal mixer 274. The preliminary recirculation waveguide 278 carries the preliminary recirculation signal to a second splitter 279. The second splitter 279 divides the preliminary recirculation signal into a delayed signal and the recirculation signal. The recirculation waveguide 275 receives the recirculation signal from the second splitter 279 and carries the recirculation signal back to the signal mixer 274. The recirculation waveguide 275 can include a delay section 280 that can be used to increase the length of the recirculation waveguide 275 while reducing the portion of the LIDAR chip occupied by the recirculation waveguide 275. For instance, the delay section 280 shown in FIG. 6A can represent a spiral arrangement of a portion of the recirculation waveguide 275. In some instances, the second splitter 279 is configured such that a power ratio of the power of the delayed signal: the power of the recirculation signal is greater than 0.5:1 and less than 1.5. In some instances, the second splitter 279 is configured such that a power ratio of the power of the delayed signal: the power of the recirculation signal is, or is substantially, 1:1.

A delayed waveguide 281 receives the delayed signal from the second splitter 279. The delayed waveguide 281 carries the delayed signal to a third splitter 282. The third splitter 282 divides the delayed signal into a first portion of the delayed signal and a second portion of the delayed signal. A first delayed waveguide 283 carries the first portion of the delayed signal to a first signal combiner 284. A second delayed waveguide 285 carries the second portion of the delayed signal to a second signal combiner 286.

The first splitter 272 divides the expedited signal into a first portion of the expedited signal and a second portion of the expedited signal. A first expedited waveguide 290 carries the first portion of the expedited signal to the first signal combiner 284. A second expedited waveguide 292 carries the second portion of the expedited signal to the second signal combiner 286.

In the embodiment of FIG. 6A, the delayed signal, the circulated signal, the preliminary recirculation signal, the recirculation signal, the delay signal, the tapped signal and the dump signal include light from the outgoing LIDAR signal. In the embodiment of FIG. 6A, the delayed signal, the circulated signal, the preliminary recirculation signal, the recirculation signal, and the dump signal include light from the tapped signal. In the embodiment of FIG. 6A, the delayed signal, the circulated signal, and the recirculation signal include light from the preliminary recirculation signal. In the embodiment of FIG. 6A, the circulated signal includes light from the preliminary recirculation signal, the recirculation signal, the outgoing LIDAR signal, the tapped signal, and the delay signal. In the embodiment of FIG. 6A, the first portion of the delayed signal and the second portion of the delayed signal include light from the delayed signal. The expedited signal includes light from the outgoing LIDAR signal. In the embodiment of FIG. 6A, the first portion of the expedited signal and the second portion of the expedited signal include light from the expedited signal.

Suitable splitters for uses as the splitter 270, the first splitter 272, the second splitter 279, the third splitter 282 include, but are not limited to, directional couplers, optical couplers, y-junctions, tapered couplers, and Multi-Mode Interference (MMI) devices. Suitable signal mixers for use as the signal mixer 274 include, but are not limited to 2×2 directional couplers, Multi-Mode Interference (MMI) devices.

The second signal combiner 286 combines the second portion of the expedited signal and the second portion of the delayed signal into a second beating signal that can serve as the output of the interferometer. The second portion of the delayed signal is delayed relative to the second portion of the expedited signal. Because the electronics can tune the frequency of the outgoing LIDAR signal, the delay causes the second portion of the delayed signal to have a different frequency than the second portion of the expedited signal. Due to the difference in frequencies between the second portion of the expedited signal and the second portion of the delayed signal, the second beating signal is beating at a beat frequency.

The second signal combiner 286 also splits the second beating signal onto a first auxiliary detector waveguide 294 and a second auxiliary detector waveguide 296. The first auxiliary detector waveguide 294 carries a first portion of the second beating signal to a first auxiliary light sensor 298 that converts the first portion of the second beating signal to a first auxiliary electrical signal. The second auxiliary detector waveguide 296 carries a second portion of the second beating signal to a second auxiliary light sensor 300 that converts the second portion of the second beating signal to a second auxiliary electrical signal. Examples of suitable light sensors include germanium photodiodes (PDs), and avalanche photodiodes (APDs).

In some instances, the second signal combiner 286 splits the second beating signal such that the portion of the expedited signal (i.e. the portion of the second portion of the expedited signal) included in the first portion of the second beating signal is phase shifted by 180° relative to the portion of the expedited signal (i.e. the portion of the second portion of the expedited signal) in the second portion of the second beating signal but the portion of the delayed signal (i.e. the portion of the second portion of the delayed signal) in the second portion of the second beating signal is not phase shifted relative to the portion of the delayed signal (i.e. the portion of the second portion of the delayed signal) in the first portion of the second beating signal.

The first signal combiner 284 combines the first portion of the expedited signal and the first portion of the delayed signal into a first beating signal that can serve as the output of the interferometer. The delay section 279 delays the first portion of the delayed signal relative to the first portion of the expedited signal. As a result, the first portion of the delayed signal is delayed relative to the first portion of the expedited signal. The delay causes the first portion of the delayed signal to have a different frequency than the first portion of the expedited signal. Due to the difference in frequencies between the first portion of the expedited signal and the first portion of the delayed signal, the first beating signal is beating at a beat frequency.

The first signal combiner 284 also splits the first beating signal onto a first detector waveguide 302 and a second detector waveguide 304. The first detector waveguide 302 carries a first portion of the first beating signal to a first light sensor 306 that converts the first portion of the second beating signal to a first electrical signal. The second detector waveguide 304 carries a second portion of the second beating signal to a second light sensor 308 that converts the second portion of the second beating signal to a second electrical signal. Examples of suitable light sensors include germanium photodiodes (PDs), and avalanche photodiodes (APDs).

In some instances, the first signal combiner 284 splits the first beating signal such that the portion of the expedited signal (i.e. the portion of the first portion of the expedited signal) included in the first portion of the beating signal is phase shifted by 180° relative to the portion of the expedited signal (i.e. the portion of the first portion of the expedited signal) in the second portion of the beating signal but the portion of the delayed signal (i.e. the portion of the first portion of the delayed signal) in the first portion of the beating signal is not phase shifted relative to the portion of the delayed signal (i.e. the portion of the first portion of the delayed signal) in the second portion of the beating signal.

When the second signal combiner 286 splits the second beating signal such that the portion of the expedited signal in the first portion of the second beating signal is phase shifted by 180° relative to the portion of the expedited signal in the second portion of the second beating signal, the first signal combiner 284 also splits the beating signal such that the portion of the expedited signal in the first portion of the beating signal is phase shifted by 180° relative to the portion of the expedited signal in the second portion of the beating signal.

The first delayed waveguide 283, the second delayed waveguide 285, the first expedited waveguide 290, and the second expedited waveguide 292 can be configured such that the first beating signal and the second beating signal together act as an in-phase component and quadrature component of an optical beating signal where the first beating signal is the in-phase component of the optical beating signal and the second beating signal is the quadrature component of the optical beating signal or such that the second beating signal is the in-phase component of the optical beating signal and the first beating signal is the quadrature component of the optical beating signal. Accordingly, the first beating signal and the second beating signal can serve as different components of an optical beating signal. For instance, the first delayed waveguide 283 and the second delayed waveguide 285 can be constructed to provide a phase shift between the first portion of the delayed signal and the second portion of the delayed signal while the first expedited waveguide 290 and the second expedited waveguide 292 are constructed such that the first portion of the expedited signal and the second portion of the expedited signal are in phase. As an example, the first delayed waveguide 283 and the second delayed waveguide 285 can be constructed so as to provide a 90° phase shift between the first portion of the delayed signal and the second portion of the delayed signal. Accordingly, one of the delayed signal portions can be a sinusoidal function and the other delayed signal portion can be a cosine function operating on the same argument as the sinusoidal function. In one example, the first delayed waveguide 283 and the second delayed waveguide 285 are constructed such that the first portion of the delayed signal is a cosine function and the second portion of the delayed signal is a sine function. In this example, the portion of the delayed signal in the second beating signal is phase shifted relative to the portion of the delayed signal in the first beating signal, however, the portion of the expedited signal in the first beating signal is not phase shifted relative to the portion of the expedited signal in the second beating signal.

In another example, the first delayed waveguide 283 and the second delayed waveguide 285 are constructed such that the first portion of the delayed signal and the second portion of the delayed signal are in phase while the first expedited waveguide 290 and the second expedited waveguide 292 are constructed to provide a phase shift between the first portion of the expedited signal and the second portion of the expedited signal. As an example, the first expedited waveguide 290 and the second expedited waveguide 292 can be constructed so as to provide a 90° phase shift between the first portion of the expedited signal and the second portion of the expedited signal. Accordingly, one of the expedited signal portions can be a sinusoidal function and the other expedited signal portion can be a cosine function operating on the same argument as the sinusoidal function. In one example, the first expedited waveguide 290 and the second expedited waveguide 292 are constructed such that the first portion of the expedited signal is a cosine function and the second portion of the expedited signal is a sine function operating on the same argument as the cosine function. In this example, the portion of the expedited signal in the second beating signal is phase shifted relative to the portion of the expedited signal in the first beating signal, however, the portion of the delayed signal in the first beating signal is not phase shifted relative to the portion of the delayed signal in the second beating signal.

As noted above, the recirculation waveguide 275 receives a portion of the light from the delay signal at the second splitter 279. The portion of the delay signal light that the recirculation waveguide 275 receives from the second splitter 279 can serve as the recirculation signal. The recirculation waveguide 275 carries the recirculation signal to the signal mixer 274 where the light is re-combined with light from the delay signal. The signal mixer 274 is located upstream of the second splitter 279. As a result, the recirculation waveguide 275 is configured to receive light from the delay signal at a first location and carry the light to a second location where the light is re-combined with the delay signal. The upstream re-combination of the recirculated light from the delay signal with the delay signal allows the light from the delay signal to recirculate in the recirculation waveguide 275. The light from the delay signal recirculates on a recirculation pathway that includes the pathways through the preliminary recirculation waveguide 278, the second splitter 279, the recirculation waveguide 275, and the signal mixer 274. Different portions of the light from the delay signal can pass through the recirculation pathway one or more times. For instance, a first portion of the light from the delay signal can pass through the recirculation pathway once before being combined with light from the expedited signal; a second portion of the light from the delay signal can pass through the recirculation pathway twice before being combined with light from the expedited signal; a third a second portion of the light from the delay signal can pass through the recirculation pathway three times before being combined with light from the expedited signal; etc. Accordingly, the same portion of the light from the delay signal can circulate through the recirculation pathway one or more times. Since the delay signal includes light from the outgoing LIDAR signal, different portions of the light from the outgoing LIDAR signal can pass through the recirculation pathway one or more times. For instance, a first portion of the light from the outgoing LIDAR signal can pass through the recirculation pathway once before being combined with light from the expedited signal; a second portion of the light from the outgoing LIDAR signal can pass through the recirculation pathway twice before being combined with light from the expedited signal; a third a second portion of the light from the outgoing LIDAR signal can pass through the recirculation pathway three times before being combined with light from the expedited signal; etc. Accordingly, the same portion of the light from the outgoing LIDAR signal can circulate through the recirculation pathway one or more times. Since the delay signal includes light from the tapped signal, different portions of the light from the tapped signal can pass through the recirculation pathway one or more times. For instance, a first portion of the light from the tapped signal can pass through the recirculation pathway once before being combined with light from the expedited signal; a second portion of the light from the tapped signal can pass through the recirculation pathway twice before being combined with light from the expedited signal; a third a second portion of the light from the tapped signal can pass through the recirculation pathway three times before being combined with light from the expedited signal; etc. Accordingly, the same portion of the light from the tapped signal can circulate through the recirculation pathway one or more times. Light from the outgoing LIDAR signal, the tapped signal, and/or the delay signal that passes through the optical recirculation pathway one or more times can serve as a circulated signal that includes light from the outgoing LIDAR signal, the tapped signal, and/or the delay signal. The light from the outgoing LIDAR signal, the tapped signal, and/or the delay signal combined with the light from the expedited signal can serve as the output from the interferometer. As a result, the circulated signal can pass through the recirculation pathway one or more times before light from the circulated signal is included in the output of the interferometer.

The ability of the light from the delay signal to pass through the recirculation pathway one or more times before being combined with light from the expedited signal introduces harmonics into the optical beating signal and the resultant data signals. To illustrate the presence of these harmonics, FIG. 6B is a graph showing experimental results for the magnitude of the first beating signal versus the beat frequency of the first beating signal, the magnitude of the second beating signal versus the beat frequency of the second beating signal, the magnitude of the third beating signal versus the beat frequency of the third beating signal, and the magnitude of the fourth beating signal versus the beat frequency of the fourth beating signal. There are four peaks in the magnitude of the beating signal. The peaks are labeled “first harmonic” through “fourth harmonic.” The peak labeled “first harmonic” is a result of a first portion of the light from the delay signal making a single pass through the recirculation pathway before being combined with light from the expedited signal so as to form the optical beating signal and the resultant data signals. The peak labeled “second harmonic” is a result of a second portion of the light from the delay signal making two passes through the recirculation pathway before being combined with light from the expedited signal so as to form the optical beating signal and the resultant data signals. The peak labeled “second harmonic” is a result of a third portion of the light from the delay signal making three passes through the recirculation pathway before being combined with light from the expedited signal so as to form the optical beating signal and the resultant data signals. The peak labeled “fourth harmonic” is a result of a fourth portion of the light from the delay signal making four passes through the recirculation pathway before being combined with light from the expedited signal so as to form the optical beating signal and the resultant data signals. The different harmonic in FIG. 6B can be associated with a harmonic index nₕ that identifies the order of the harmonic. The peak labeled “first harmonic” (nₕ=1) can represent the fundamental harmonic. The presence of the higher harmonics in FIG. 5B establishes that light from the delay signal is present in the delayed signal, and in the resultant optical beating signal, after multiple passes through the recirculation pathway.

Prior LIDAR systems used light from the first harmonic to control the frequency versus time pattern of a controlled signal such as the outgoing LIDAR signal. In contrast to the prior LIDAR systems, the current LIDAR system is configured to use a portion of the circulated signal that has made multiple passes through the recirculation pathway to control the frequency versus time pattern of the controlled signal. Accordingly, the LIDAR system is configured to use the higher harmonics to control the frequency versus time pattern of the controlled signal. Although the tapped signal is described as the controller signal, other signals can also serve as the controlled signal or can alternately serve as the controlled signal. For instance, the tapped signal includes light from the outgoing LIDAR signal. The LIDAR output signal and the system output signal also include light from the outgoing LIDAR. As a result, the LIDAR output signal, the system output signal and/or the outgoing LIDAR can serve as the controlled signal in addition to the tapped signal serving as the controlled signal or as an alternative to the tapped signal serving as the controlled signal.

Using higher harmonics to control the frequency versus time pattern of the controlled signal allows the length of the recirculation pathway to be reduced. For instance, the length of the recirculation pathway can be equal to (1/(nₕ))*(the length of the recirculation pathway for a LIDAR system where the fundamental harmonic is the only harmonic used to control the frequency versus time pattern of the controlled signal). Accordingly, the length of the recirculation pathway can be equal to (1/(nₕ))*(the length of the recirculation pathway where light from a delay signal is makes a single pass through the recirculation pathway before being combined with light from an expedited signal). As an example, the length of the recirculation pathway that provided FIG. 6B can be halved and the portion of the delay signal that has traveled around the recirculation pathway twice before being combined with light from the expedited signal can be used to control the frequency versus time pattern of the controlled signal. Since the length of the recirculation pathway is halved relative to FIG. 6B but the light from the delay signal that is used to control the frequency versus time pattern travels around the recirculation pathway twice before being combined with light from the expedited signal, the light from the delay signal that is used to control the frequency versus time pattern travels about the same distance through the recirculation pathway as was traveled by the light that provides the fundamental harmonic of FIG. 6B. Accordingly, this example provides the same level of time delay to the light used to control the frequency versus time pattern as is provided by the recirculation pathway of FIG. 6B using a shorter recirculation pathway. Although this example halves the length of the recirculation pathway, other fractions of the recirculation pathway length can be sued. For instance, when the length of the recirculation pathway is (1/(nₕ))*(the length of the recirculation pathway for a LIDAR system where the fundamental harmonic is the only harmonic used to control the frequency versus time pattern of the controlled signal), the nₕ can be used to control the frequency versus time pattern of the controlled signal. Accordingly, when the length of the recirculation pathway is (1/(nₕ))*(the length of the recirculation pathway for a LIDAR system where the fundamental harmonic is the only harmonic used to control the frequency versus time pattern of the controlled signal), the frequency versus time pattern of the controlled signal can be controlled using an active portion of the circulated signal that has passed through the recirculation pathway nₕ times. The value of nₕ times can serve as the active number of passes and can be expressed as nₕₜ. As a result, nₕₜ can represent the harmonic that the LIDAR system uses to control the frequency versus time pattern of the controlled signal and can be considered the active harmonic. In contrast, an inactive portion of the circulated signal that passed through the recirculation pathway for a number of times other than nₕₜ are not used to control the frequency versus time pattern of the controlled signal. The inactive portion of the circulated signal can refer to one or more different portions of the circulated signal. For instance, an inactive portion of the circulated signal can refer to a portion of the circulated signal having different frequency ranges separated by the frequency range of the active portion of the circulated signal. Each value of nₕ for one of the times other than nₕ can serves as an inactive number of passes and can be expressed as nₕᵢ. As a result, nₕᵢ can represent a harmonic that the LIDAR system does not use to control the frequency versus time pattern of the controlled signal and can be considered an inactive harmonic. As an example, where the portion of the circulated signal that passes through the recirculation pathway twice is used to control the frequency versus time pattern of the controlled signal, the value of nₕₜ=2 and there can be multiple inactive harmonics that can each be represented by a nₕᵢ value. For instance, when nₕₜ=2 the nₕᵢ values can be” nₕᵢ=1, nₕᵢ=2, nₕᵢ=3 and can be higher depending on the number of harmonics that are evident in the output of the interferometer.

The expedited signal travels an expedited pathway from the splitter 270 to the first signal combiner 284 and/or the second signal combiner 286. For instance, the expedited waveguide 271 and the first expedited waveguide 290 can define at least a portion of the length of an expedited pathway from the splitter 270 to the first signal combiner 284. In some instances, a length of an expedited pathway can be the distance that that light from the expedited signal travels from the splitter 270 to the to the first signal combiner 284 and/or the second signal combiner 286.

Light from the delay signal travels a delay pathway from the splitter 270 to the first signal combiner 284 and/or the second signal combiner 286. For instance, a delay branch waveguide 273, preliminary recirculation waveguide 278, recirculation waveguide 275, delayed waveguide 281, and first delayed waveguide 283 can define at least a portion of a delay pathway from the splitter 270 to a first signal combiner 284 and/or a second signal combiner 286. Accordingly, the length of a delay pathway can include the length of the recirculation pathway. In some instances, the length of a delay pathway can be the distance that that light included in the first harmonic travels from the splitter 270 to the to the first signal combiner 284 and/or the second signal combiner 286. The lengths of the delay pathway(s) and the expedited pathway(s) are selected to provide an interferometer time delay (τ_{d}) between the time needed for light from the expedited signal to travel an expedited pathway to the first signal combiner 284 and the time needed for light from the delay signal that travels the recirculation pathway the active number of passes (nₕₜ) to traveling a delay pathway to the same one of the light combiners. Suitable values for τ_{d} include, but are not limited to, times greater than 1 ns, 5 ns, or 10 ns and less than 20 ns, 25 ns, 30 ns, or 500 ns.

The length of the recirculation pathway can be selected to provide a circulation time for the circulated signal to make a single pass through the recirculation pathway. The length of the delay pathway can be selected to provide a delay pathway time. The delay pathway time represents the time for the light from the delay signal to travel the delay pathway while making a single pass through the recirculation pathway. In some instance, the length of the recirculation pathway and/or the length of the delay pathway are selected such that the delay pathway time is substantially the same as the circulation time. Suitable circulation times and/or delay pathway times include, but are not limited to, times greater than 5 ns, 2.5 ns, or 0.5 ns and less than 15 ns, 12.5 ns, or 10 ns. In one example where the second harmonic (nₕₜ=2) is used to control the frequency versus time pattern, the length of the recirculation pathway and/or the delay pathway is selected to provide a circulation time and/or delay pathway time greater than 5 ns, 2.5 ns, or 0.5 ns and less than 15 ns, 12.5 ns, or 10 ns. In one example where the third harmonic (nₕₜ=3) is used to control the frequency versus time pattern, the length of the recirculation pathway and/or the delay pathway is selected to provide a circulation time and/or delay pathway time greater than 3 ns, 1.7 ns, or 0.3 ns and less than 10 ns, 8 ns, or 7 ns. As a result, the length of the recirculation pathway and/or the delay pathway is selected to provide a circulation time and/or delay pathway time that is greater than 5%, 10%, or 25% and less than 70%, 55%, or 45% of the interferometer time delay (τ_{d}).

The first light sensor 306 and the second light sensor 308 can be connected as a balanced detector and the first auxiliary light sensor 298 and the second auxiliary light sensor 300 can also be connected as a balanced detector. For instance, FIG. 6C provides a schematic of the relationship between the light source 4, the electronics 32, and the first light sensor 306, the second light sensor 308, the first auxiliary light sensor 298, and the second auxiliary light sensor 300 from the control components 30. As a result, FIG. 6C can represent an example of a suitable feedback loop 34 for use with the LIDAR system. In FIG. 6C, the symbol for a photodiode is used to represent the first light sensor 306, the second light sensor 308, the first auxiliary light sensor 298, and the second auxiliary light sensor 300 but one or more of these sensors can have other constructions. In some instances, all of the components illustrated in the schematic of FIG. 6C are included on the LIDAR chip. In some instances, the components illustrated in the schematic of FIG. 6C are distributed between the LIDAR chip and electronics located off of the LIDAR chip.

The electronics connect the first light sensor 306 and the second light sensor 308 as a first balanced detector 312 and the first auxiliary light sensor 298 and the second auxiliary light sensor 300 as a second balanced detector 314. In particular, the first light sensor 306 and the second light sensor 308 are connected in series. Additionally, the first auxiliary light sensor 298 and the second auxiliary light sensor 300 are connected in series. The serial connection in the first balanced detector is in communication with a first data line 316 that carries the output from the first balanced detector as a first electrical beating signal. The serial connection in the second balanced detector is in communication with a second data line 318 that carries the output from the second balanced detector as a second electrical beating signal.

The first electrical beating signal is an electrical representation of the first beating signal and the second electrical beating signal is an electrical representation of the second beating signal. Accordingly, the first electrical beating signal is beating at a beat frequency and the second electrical beating signal is beating at a beat frequency. Additionally, the first electrical beating signal and the second electrical beating signal can each carry a different one of the components selected from a group consisting of the in-phase component of an electrical beating signal and the quadrature component of the electrical beating signal. Accordingly, the first electrical beating signal and the second electrical beating signal can serve as different components of an electrical beating signal. The first electrical beating signal can include a contribution from a first waveform and a second waveform and the second electrical beating signal can include a contribution from the first waveform and the second waveform. The portion of the first waveform in the first electrical beating signal is phase-shifted relative to the portion of the first waveform in the second electrical beating signal but the portion of the second waveform in the first electrical beating signal is in-phase relative to the portion of the second waveform in the second electrical beating signal. For instance, the second electrical beating signal can include a portion of the delayed signal that is phase shifted relative to a different portion of the delayed signal that is included the first electrical beating signal. Additionally, the second electrical beating signal can include a portion of the expedited signal that is in-phase with a different portion of the expedited signal that is included in the first electrical beating signal. The first electrical beating signal and the second electrical beating signal are each beating as a result of the beating between the expedited signal and the delayed signal, i.e. the beating in the first beating signal and in the second beating signal.

The electronics 32 includes a control data processor 319 configured to generate a control signal from the electrical beating signal. The control data processor 319 can apply the control signal to the light source. The control signal is generated such that the application of the control signal to the light source provides the controlled signal with the desired frequency versus time pattern. The control data processor 319 includes a frequency identifier 320 the receives the electrical beating signal. The frequency identifier 320 is configured to identify the frequency of the controlled signal. The frequency identifier 320 includes a first Analog-to-Digital Converter (ADC) 322 that receives the first electrical beating signal from the first data line 316. The first Analog-to-Digital Converter (ADC) 322 converts the first electrical beating signal from an analog form to a digital form and outputs a first digital signal. The frequency identifier 320 includes a second Analog-to-Digital Converter (ADC) 324 that receives the second electrical beating signal from the first data line 316. The second Analog-to-Digital Converter (ADC) 324 converts the second electrical beating signal from an analog form to a digital form and outputs a second digital data signal. The first digital data signal is a digital representation of the first electrical beating signal and the second digital data signal is a digital representation of the second electrical beating signal. Accordingly, the first digital data signal and the second digital data signal act together as components of a digital beating signal where the first digital data signal acts as the in-phase component of the digital beating signal and the second digital data signal acts as the quadrature component of the digital beating signal.

The frequency identifier 320 includes a first filter 326 that receives the first digital data signal from the first Analog-to-Digital Converter (ADC) 322. The first filter 326 is configured to filter out of the first digital data signal the frequencies that can result from the presence of the inactive harmonics in the optical beating signal. As a result, the first digital data signal output from the first filter 326 retains the range of frequencies that can result from the active harmonic while having a reduced contribution from the ranges of frequencies that can result from the inactive harmonics. Accordingly, the first digital data signal output from the first filter 326 retains the contribution from light that has traveled around the recirculation pathway nₕₜ times but the contribution to the first digital data signal output from light that has traveled around the recirculation pathway nₕᵢ times is reduced or eliminated. The second filter 328 is configured to filter out of the second digital data signal the frequencies that can result from the presence of the inactive harmonics in the optical beating signal. As a result, the second digital data signal output from the second filter 328 retains the range of frequencies that can result from the active harmonic while having a reduced contribution from the ranges of frequencies that can result from the inactive harmonics. Accordingly, the first digital data signal output from the first filter 326 retains the contribution from light that has traveled around the recirculation pathway nₕₜ times but the contribution to the first digital data signal output from the light that has traveled around the recirculation pathway nₕᵢ times is reduced or eliminated. The first filter 326 and second filter 328 can be positioned at other locations in the LIDAR system. For instance, the first filter 326 and second filter 328 can be configured to receive and filter the first electrical beating signal and the second electrical beating signal so as to reduce or remove the contribution from the ranges of frequencies that result from the inactive harmonics. Accordingly, the first filter 326 and second filter 328 can be configured to filter analog electrical signals. Alternately, the first filter 326 and second filter 328 can be configured to filter optical signals. For instance, the first filter 326 and second filter 328 can be configured to receive and filter the first portion of the delayed signal and the second portion of the delayed signal so as to reduce or remove the contribution from the ranges of frequencies that result from the inactive harmonics. Since the first digital data signal, the second digital data signal, the first electrical beating signal, the second electrical beating, the first portion of the delayed signal and the second portion of the delayed signal are each generated from the circulated signal and/or contain a contribution form the circulated signal, these signals can serve as circulation resultant signals used in controlling the frequency versus time pattern of the controlled signal. Accordingly, the LIDAR system can include one or more filters that are each configured to filter out the contributions of inactive harmonics to a circulation resultant signal. Suitable filters for use as a first filter 326 and/or a second filter 328 include, but are not limited to, band pass filters.

The frequency identifier 320 includes a frequency evaluator 330 that receives the digital beating signal. For instance, the frequency evaluator 330 receives the filtered first digital data signal and the filtered second digital data signal. The filtered first digital data signal and the filtered second digital data signal can act as the in-phase and quadrature components of a digital data signal. When the first filter 326 and second filter 328 are absent or are not located as shown in FIG. 6C, the frequency identifier 320 receives the first digital data signal and the second digital data signal. The first digital data signal and the second digital data signal can act as the in-phase and quadrature components of a digital data signal. The frequency evaluator 330 can be configured to identify the frequency of the controlled signal (f_{c}) at a point in time. For instance, the frequency evaluator 330 can be configured to calculate the frequency of the controlled signal at a point in time according to f_{c}=f₀+atan(filtered first digital data signal/filtered second digital data signal)/(2πτ_{d}) where τ_{d} represents the interferometer time delay, f₀ represents the base frequency, and the value of the filtered signals are taken at the time associated the f_{c} value. The frequency evaluator 330 can calculate multiple different values for frequency of the controlled signal (f_{c}) during a chirp period. For instance, FIG. 6D includes multiple different values for frequency of the controlled signal (f_{c}) overlaid on the frequency versus time pattern of the controlled signal shown in FIG. 5C. Each of the controlled signal frequency values is labeled f_{c} and represents the frequency of the controlled signal within the same chirp. The frequency evaluator 330 outputs indicator signals that can also serve as the output of the frequency identifier 320. The indicator signals indicate the values for frequency of the controlled signal (f_{c}).

The control data processor 319 includes a source controller 332 that can receive the indicator signals. The source controller 332 can use the indicator signals to modify the control signal being applied to the light source 4. For instance, the source controller 332 can perform a line fit so as to fit a line to the controlled signal frequency values (f_{c}). The dashed line labeled “line fit” in FIG. 6D can represent an example of a line fit to the signal frequency values (f_{c}) shown in FIG. 6D. The fit line can serve as an output line. The control data processor 319 can compare the output line to the line resulting from the desired chirp (the desired chirp line) so as to determine the level of error in the output line relative to the desired linear chirp. For instance, the source controller 332 can calculate the difference between the slope of the output line and the slope of the desired chirp line. An increased difference the slopes indicates an increased level of error. The source controller 332 can modify the control signal applied to the light source. For instance, the source controller 332 can modify the control signal in a way that moves the slope of the output line and the slope of the desired chirp line. The source controller 332 can apply the modified control signal to the light source 4 such that the modified control signal serves as the currently applied control signal. The modified control signal serving as the currently applied control signal can serve as the output of the source controller 332 and accordingly as the output of the control data processor 319.

The modified control signal is applied to the light source during one or more chirp periods that are each subsequent to, and correspond to, the chirp period containing the controlled signal frequency values (f_{c}) used to modify the control signal. For instance, the signal frequency values (f_{c}) shown in FIG. 6D are associated with times within the chirp period labeled DP₁ of the cycle labeled cycleⱼ. FIG. 6D includes a line labeled “modified control signal” that can represent the modified control signal resulting from the signal frequency values (f_{c}) shown in FIG. 6D being applied to the light source during the chirp period labeled DP₁ of the cycle labeled cycleⱼ₊₁. In this example, the chirp period labeled DP₁ of the cycle labeled cycleⱼ₊₁ corresponds to the chirp period labeled DP₁ of the cycle labeled cycleⱼ and is subsequent to the chirp period labeled DP₁ of the cycle labeled cycleⱼ. As a result, in this example, the modified control signal is applied during the next corresponding chirp period after the last chirp period containing the controlled signal frequency values (f_{c}) used to generate the modified control signal.

Although a modified control signal is described as being generated from a single output line, a modified control signal can be generated from multiple different output lines. For instance, the source controller 332 can generate controlled signal frequency values (f_{c}) for multiple different corresponding chirp periods. The source controller 332 can generate output lines from each of the multiple different corresponding chirp periods. The source controller 332 can combine the multiple output lines to generate an operative output line that is used in generating the modified control signal. For instance, the source controller 332 can average the multiple output lines to generate an operative output line that is used in generating the modified control signal.

Each of the control signals is associated with one of the period indices. For instance, the control signals disclosed in the context of FIG. 6D are for the corresponding chirp periods labeled DP₁. As a result, the control signals disclosed in the context of FIG. 6D are associated with the period index k=1. However, controlled signal frequency values (f_{c}) and output lines can be generated for other chirp periods. For instance, different controlled signal frequency values (f_{c}), output lines, and control signals can be generated for each one of the period indices in the frequency versus time pattern of the controlled signal. Alternately, controlled signal frequency values (f_{c}), output lines, and control signals can be generated for each one of the period indices in a portion of the total number of period indices in the frequency versus time pattern of the controlled signal. Accordingly, different control signals can be generated for the chirp periods labeled DP₁ than are generated for the chirp periods labeled DP₂.

The source controller 332 can repeat the process of receiving indicator signals and using the indicator signals to modify the control signal so as to provide the controlled signal with the desired frequency versus time pattern. Accordingly, the light source, control branch 26, control components 30, frequency identifier 320, and source controller 332 provide a feedback loop.

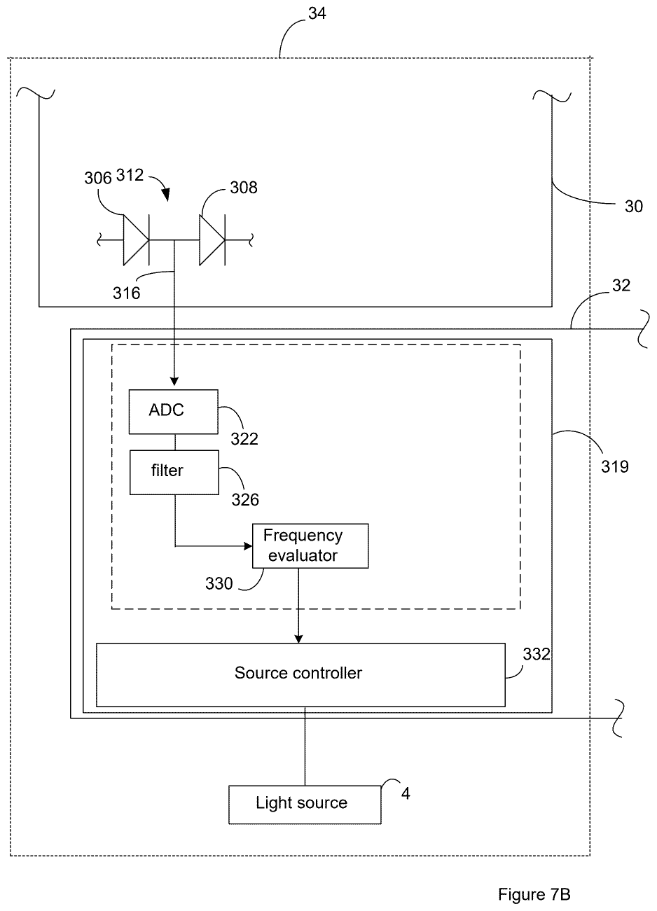

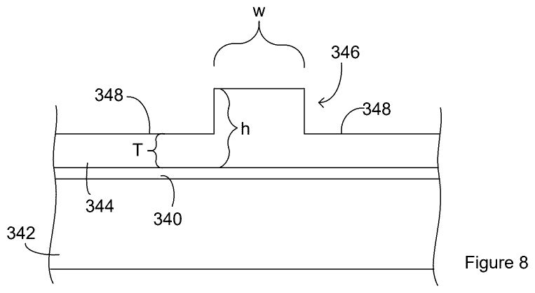

The feedback loop described in the context of FIG. 6A through FIG. 6D makes use of optical signals and electrical signals that have an in-phase component and a quadrature component. However, the feedback loop described in the context of FIG. 6A through FIG. 6D can be adapted for use with an in-phase component or a quadrature component. As an example, FIG. 7A illustrates the interface between optical components and light sensors of FIG. 6A modified so as to exclude the components that generate and/or process either the quadrature component of the signals or the in-phase component of the signals. As a result, the interface shown in FIG. 7A generates the first beating signals without generating the second beating signals, or generates the second beating signals without generating the first beatings signals. As a result, the first beating signal or the second beating signal can serve as the optical beating signal and the optical beating signal can serve as the output of the interferometer. Additionally, FIG. 7B illustrates the schematic of the relationship between the light sources, electronics, and light sensors of FIG. 6C modified so as to process the output from the interface between optical components and light sensors illustrated in FIG. 7A. In FIG. 7B, the filtered first digital data signal is generated but the second digital data signal is not generated or the filtered second digital data signal is generated but the first digital data signal is not generated. As a result, the frequency evaluator 330 receives the filtered first digital data signal or the filtered second digital data signal. The frequency evaluator 330 can calculate the controlled signal frequency values (f_{c}) by counting the frequency of the baseline crossing of the filtered first digital data signal or the filtered second digital data signal.

FIG. 8 is a cross section of a portion of a LIDAR chip that includes a waveguide construction that is suitable for use in LIDAR chips constructed from silicon-on-insulator wafers. A silicon-on-insulator wafer has a buried oxide layer 340 between a silicon substrate 342 and a silicon light-transmitting medium. In FIG. 8, a ridge 346 of the light-transmitting medium extends away from slab regions 348 of the light-transmitting medium. The light signals are constrained between the top of the ridge 346 and the buried oxide layer 340.

The dimensions of the ridge waveguide are labeled in FIG. 8. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction disclosed in the context of FIG. 8 is suitable for all or a portion of the waveguides on LIDAR chips constructed according to FIG. 1A through FIG. 1C.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

The light source 4 that is interfaced with the utility waveguide 12 can be a laser chip that is separate from the LIDAR chip and then attached to the LIDAR chip. For instance, the light source 4 can be a laser chip that is attached to the chip using a flip-chip arrangement. Use of flip-chip arrangements is suitable when the light source 4 is to be interfaced with a ridge waveguide on a chip constructed from silicon-on-insulator wafer. Alternately, the utility waveguide 12 can include an optical grating (not shown) such as Bragg grating that acts as a reflector for an external cavity laser. In these instances, the light source 4 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017 and in U.S. Pat. No. 5,991,484 issued on Nov. 23 1999; each of which is incorporated herein in its entirety. When the light source 4 is a gain element or laser chip, the electronics 32 can change the frequency of the outgoing LIDAR signal by changing the level of electrical current applied to through the gain element or laser cavity.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable data processor 236 executes the attributed functions using firmware, hardware, or software or a combination thereof. An example of a suitable steering controller 143 executes the attributed functions using firmware, hardware, or software or a combination thereof. An example of a suitable frequency identifier 320 executes the attributed functions using firmware, hardware, or software or a combination thereof. An example of a suitable source controller 332 executes the attributed functions using firmware, hardware, or software or a combination thereof.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demulitplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demulitplexers, tunable multiplexers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output a system output signal that travels away from the LIDAR system and can be reflected by an object located outside of the LIDAR system,
the system output signal including light from an outgoing LIDAR signal; and
the LIDAR system including a feedback loop configured to control a frequency versus time pattern of the system output signal,
the feedback loop including an interferometer with a recirculation pathway, and
the interferometer being configured such that a circulated signal travels through the recirculation pathway multiple times before being included in an output of the interferometer,
the circulated signal including light from the outgoing LIDAR signal.

2. The system of claim 1, wherein the interferometer includes a light signal combiner configured to combine light from the circulated signal with light from an expedited signal so as to generate an optical beating signal,
the expedited signal including light from the outgoing LIDAR signal.

3. The system of claim 1, wherein the LIDAR system includes a frequency identifier configured to identify a frequency of the outgoing LIDAR signal.

4. The system of claim 1, wherein an active portion of the circulated signal travels through the recirculation pathway an active number of times and an inactive portion of the circulated signal travels through the recirculation pathway an inactive number of times,
the active number of times being greater than or equal to 2, and
the feedback loop being configured to use the active portion of the circulated signal to control the frequency versus time pattern of the system output signal without using the inactive portion of the signal to control the frequency versus time pattern of the system output signal.

5. The system of claim 4, wherein the feedback loop includes a filter configured to filter out a contribution of the inactive portion of the circulated signal from a circulation resultant signal,
the circulation resultant signal including a contribution from the circulated signal, and
the feedback loop being configured to use the circulation resultant signal to control the frequency versus time pattern of the system output signal.

6. The system of claim 5, wherein the circulation resultant signal is an optical signal.

7. The system of claim 6, wherein the circulation resultant signal is an electrical signal.

8. The system of claim 1, wherein the interferometer includes a light signal combiner configured to combine light from the circulated signal with light from an expedited signal so as to generate an optical beating signal that serves as an output of the interferometer,
the expedited signal including light from the outgoing LIDAR signal, and
the LIDAR system includes a frequency identifier configured to identify a frequency of the outgoing LIDAR signal.

9. The system of claim 1, wherein the recirculation pathway has a length selected such that a circulation time for the circulated signal to make a single pass through the recirculation pathway is less than 30 ns.

10. The system of claim 9, wherein the recirculation pathway has a length selected such that the circulation time is greater than 1 ns.

11. The system of claim 4, wherein the interferometer includes a light signal combiner configured to combine light from the circulated signal with light from an expedited signal so as to generate an optical beating signal that serves as an output of the interferometer,
the expedited signal including light from the outgoing LIDAR signal, and
the interferometer having a delay pathway from an input of the interferometer to the light signal combiner, the delay pathway including the recirculation pathway,
the interferometer having an expedited pathway from an input of the interferometer to the light signal combiner,
the length of the expedited pathway and the delay pathway being selected such that a difference between a time that the light from the expedited signal travels the expedited pathway and a time that light from the active portion of the circulated signal travels the delay pathway is more than 1 ns and less than 30 ns.
